(19) United States
(12) Patent Application Publication
(10) Pub. No.: US 2015/0155724 A1
(43) Pub. Date: Jun. 4, 2015

(54) PORTABLE CHARGER

(71) Applicant: SINGAPORE TECHNOLOGIES DYNAMICS PTE LTD, Singapore (SG)

(72) Inventors: Kuan Juan Han, Sengkang (SG); Ee-Ho Gareth Tang, Holland (SG); Yew Thean Cham, Coa Chu Kang (SG); Woei-Seng Howey How, Lavender District (SG)

(21) Appl. No.: 14/410,944

(22) PCT Filed: Jun. 25, 2013
(86) PCT No.: PCT/SG2013/000263

§ 371 Date: Dec. 23, 2014

Related U.S. Application Data
(60) Provisional application No. 61/664,055, filed on Jun. 25, 2012.

(30) Foreign Application Priority Data
Dec. 31, 2012 (SG) 201209671-5

(51) Int. Cl. H02J 7/00

(52) U.S. Cl. CPC H02J 7/0042

(57) ABSTRACT

The portable charger including an air outlet duct arranged at an upper end of the heat sink inside a ceiling of an housing of the portable charger, to capture and channel an heated air inside the portable charger, a heat sink on the housing at back panel and including fins matching with the air outlet duct to receive heated air, an air intake grill in the housing facing downward when the portable charger is placed in a upright position and to receive an air from an outside of the portable charger, an air intake duct coupled to the air intake grill to channel the air to an inside of the portable charger, an intake fan coupled to the air intake duct to receive the air, an air outlet at the upper end of the heat sink and at opposite end to the intake fan may be provided.

### TECHNICAL FIELD

The present invention relates to a portable charging system.

### RELATED ART

With advancement in electronics and battery technology, our life has become very reliant on portable battery powered electronic devices. This reliance on portable devices in turn required power supply be readily available to charge up these devices wherever we are. There many situations where availability of off-site power supply can determine whether a mission is to be carried out successfully. For examples, disaster relief, off-site monitoring of events, etc. With the high proliferation of mobile communication devices, the need for a remote charging station becomes ever more critical.

Reference is made to U.S. Pat. No. 7,598,703 B2 entitled “Portable chargers having power factor correction capability for use with electric vehicles”. The patent discloses a type of portable chargers with power factor correction capability for use with electric vehicles.

Reference is made to U.S. Pat. No. 7,688,027 B2 entitled “Portable battery charger to charge plural batteries”. Said document is capable of charging many batteries in a small space and enables efficient attaching and detaching operation of many batteries. However, it emphasizes on the design of the placement for the batteries being charged.

Reference is made to US 2011/0055037 A1 entitled “Stored energy and charging appliance”. Said application discloses systems and methods for storing and providing electrical power, and more particularly to devices for charging battery-based devices or powering electrical devices via a limited electrical supply. Thus, the main drawback of this application that the disclosed charging system is not portable and is bulky and heavy in weight.

Thus, there is a need to provide a light weight, easy handling charger system for easy transportation and emergency backup.

### SUMMARY

The present invention provides a portable charger Includes an air outlet duct arranged at an upper end of the heat sink inside a ceiling of an housing of the portable charger, and adapted to capture and channel an heated air inside the portable charger, a heat sink arranged on the housing of the portable charger at back panel, and comprising fins matching with the air outlet duct, and adapted to receive heated air from the air outlet duct, an air intake grill arranged in the housing of the portable charger adapted to be facing downward when the portable charger is adapted to be placed in a upright position and to receive an air from an outside of the portable charger, and an air intake duct in physical coupling to the air intake grill, and adapted to channel the air to an inside of the portable charger.

In alternative embodiments, the portable charger includes an air outlet arranged at an the upper end of the heat sink and at opposite end to the intake fan such that the air move over a wide area of the heat sink, and the intake fan physically coupled to the air intake duct to receive the air.

In alternative embodiments, the portable charger further includes an integrated power distribution module comprising a voltage measurement module adapted to detect changes in a load voltage and to provide an information related to the change in load voltage to a microcontroller, the microcontroller adapted to process the information and to provide a correction signal related to the power requirement to a power distribution module, the power distribution module adapted to regulate and control output voltages on a basis of the correction signal.

In another embodiment, the portable charger includes a hybrid power system comprising a plurality of power resources adapted to power a load, the hybrid power system functionally coupled to the power distribution module to be regulated by the power distribution module for powering the load.

In an alternative embodiments, the power charger includes a field pack output unit coupled to the hybrid power system, comprising a DC-AC output and DC-DC output, and the field pack output unit is operatively coupled to the load.

In alternative embodiments, the hybrid power system comprising a hydrogen fuel cell.

In an alternative embodiment, the portable charger includes an integrated two-way valve adapted to equalize pressure fluctuations.

In an alternative embodiment, wherein the housing is in the shape of a jerry can.

In an another alternative embodiments, wherein the housing comprises a pair of bi-axial handles provided on a side surface of the housing and a top surface of the housing along axis perpendicular to each other.

In a yet alternate embodiment, wherein the housing comprises connectors to connect the portable charger to the load, the correctors are placed at one of the edges of the housing.

In one embodiment, wherein the microcontroller is adapted to switch between the power sources to enable the hybrid power system to power the load.

The details of one or more embodiments of the invention are set forth in the accompanying drawings and the description below. Other features, objects, and advantages of the invention will be apparent from the description and drawings, and from the claims.

All publications, patents, patent applications cited herein are hereby expressly incorporated by reference for all purposes.

### BRIEF DESCRIPTION OF DRAWINGS

FIG. 1: shows an overview of portable charger comprising an electric system shaped in a jerry can.

FIG. 2: shows various component of the portable charger.

FIG. 3: shows various component of portable charger from a different view.

FIG. 4: shows enlarged view of portable charger.

FIG. 5: shows a portable charger with biaxial handlebar.

FIG. 6: shows a hybrid power system/configuration.

FIG. 7: shows a fuel cell battery hybrid power system.

### DETAILED DESCRIPTION

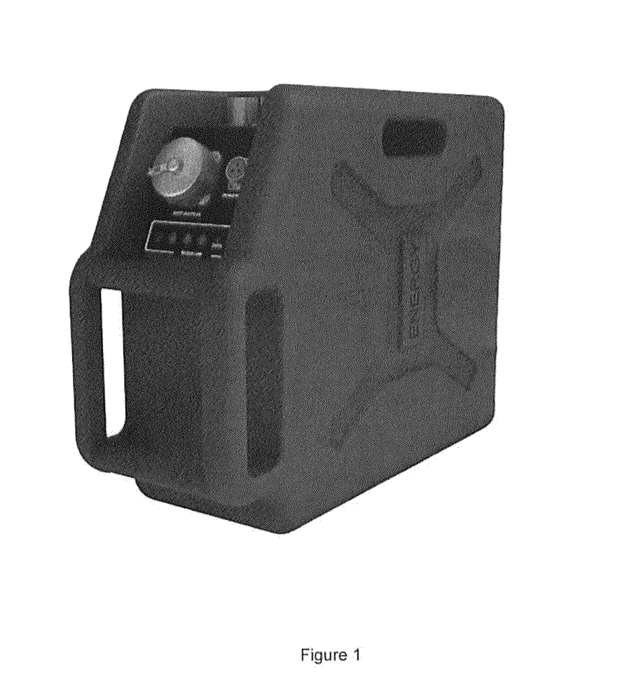

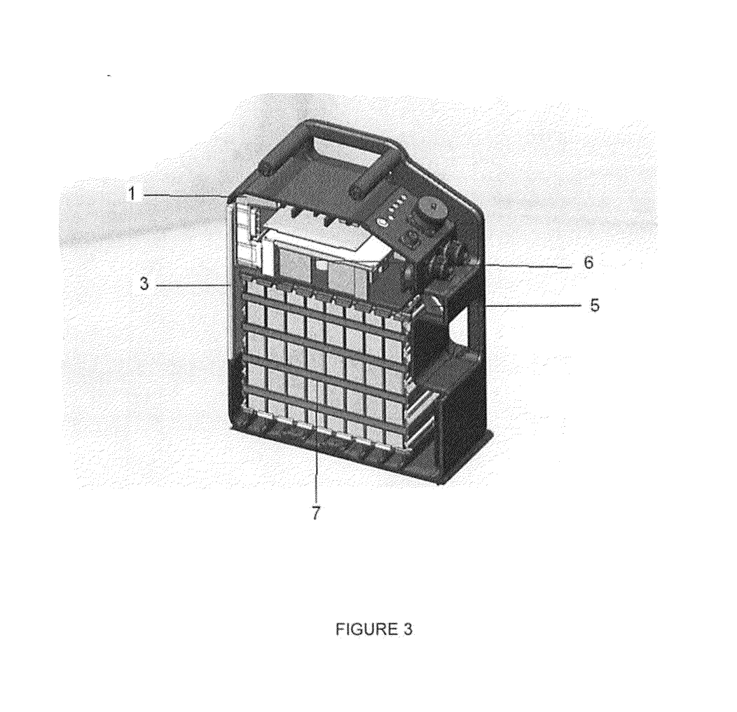

Portable chargers and portable field chargers shaped in a jerry can as illustrated in FIGS. 1 to 7 is described herein. Particularly, the portable chargers and portable field chargers of the invention are designed for outfield or outdoor use or deployment.

The invention provides portable chargers and portable field chargers that is lightweight, high power, rugged and/or built for easy handling. Devices that can be charged using this portable charger include electrically operated equipment such as portable electronic device, battery pack, light, laptop, DC/AC inverter.

The portable charger and portable field charger of present invention comprises a simple user interface, a 240 VAC output, dual USB outputs and a single 24 Vdc compatible with most outdoor equipment charging needs. In alternative embodiments the invention is ideal for military deployment, recreational off-grid power supply, emergency backup and disaster relief operation.

Various components of portable charger are as follows:
1. Embedded air outlet duct, concealed inside ceiling of product for capturing and channeling heated air.
2. Concealed air outlet, not easily noticed during normal operation, facing downwards to prevent water ingress from light rain and mild water splashes during normal used when seated in upright position.
3. Heatsink, flushed to housing, with fins matching outlet duct, 1, acting as air outlet guide.
4. Concealed air intake grill, not easily noticed during normal operation, facing downwards to prevent water ingress from light rain and mild water splashes during normal used when seated in upright position.
5. Air intake duct shaped and sized for similar cross-sectional area as air intake grill, 4, air flow to intake fan, 8.
6. Integrated electronics.
7. Integrated battery pack.
8. Air intake fan.
9. Air flow outlet direction.
10. Biaxial handle bar.
   Various components of portable charger are described in details:
   a. Electric System Shaped in a Jerry can

In alternative embodiments, the invention provides portable chargers and portable field chargers shaped in or as a jerry can, or shaped approximately as a jerry can. Jerry cans have been widely used for transportation of gas, water and other liquids. The concept of designing an electric system shaped in a jerry allows the product to be easily transported in existing infrastructure, in particular military vehicles, simplifying logistic complexity. The invention can also be easily recharged from military trucks and transporters. FIG. 1 illustrates an exemplary portable charger or portable field charger of the invention comprising an electric system shaped in a jerry can.

b. Biaxial Handlebars on the Top and Side

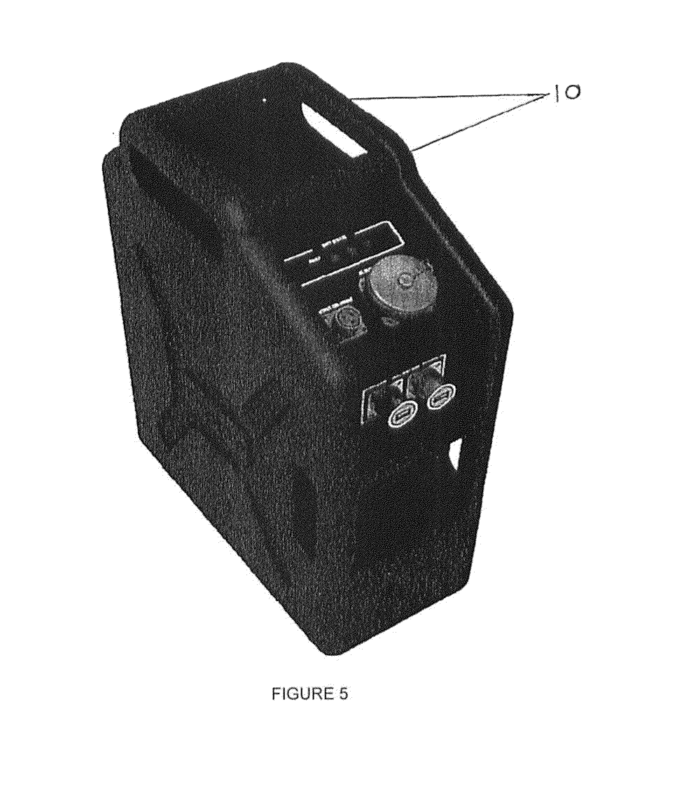

In alternative embodiments, portable chargers or portable field chargers of the invention comprise biaxial handlebars on both the top and side face to e.g., facilitate ease of handling. A carrying option is also flexible as it can be ergonomically carried by one to two men, e.g. in two perpendicular axes. This innovative biaxial design enables easy mounting and dismounting on a vehicle. FIG. 5 illustrates an exemplary portable charger or portable field charger of the invention comprising biaxial handlebars (10). Typical jerry cans only have handlebars at the top.

c. Rugged Interface

In alternative embodiments, portable chargers or portable field chargers of the invention comprise connectors flushed to the edge to protect and prevent mishandling or accidental damage. In alternative embodiments, atleast one of the connectors are flushed to the edge to protect and prevent mishandling or accidental damage.

d. Heat Sink

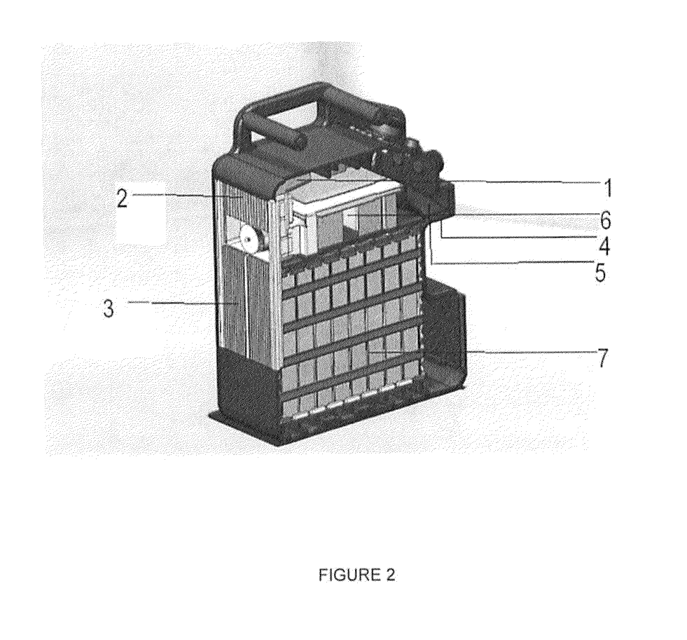

In alternative embodiments, portable chargers or portable field chargers of the invention comprise at least one integrated heat sink 3 at the back panel, away from users. This embodiment allows heat to be effectively dissipated and not affect users' handling. In alternative embodiments the integrated heatsink comprises an internal heat sink and air cooling mechanism connected to the external heat sink. In alternative embodiments a large heat sink panel avoids the need for a cooling fan and allows the electronics to be sealed and waterproofed. FIG. 2 illustrates an alternative embodiment comprising an integrated heat sink 3.

e. All-in-One User Interface Panel

In alternative embodiments, portable chargers or portable field chargers of the invention comprise an intuitive interface whereby all user interfaces are located at the front panel while the recharging port is located at the rear. This embodiment can also have a simple built-in light-emitting diode (LED) display, or equivalent, to show the battery status

f. Integrated 2 Way Valve

In alternative embodiments, portable chargers or portable field chargers of the invention are equipped with an integrated two-way (2 way) valve to equalize pressure fluctuations caused by operating the invention in different environmental conditions such as differing altitudes. For example, in the absence of the 2 way valve, when the invention is in operation at high altitude such as in high mountainous terrains, the internal pressure can exceed the external pressure, leading to casing deformity and degraded operational performance.

g. Integrated Power Distribution Module with an Innovative Control Architecture

In alternative embodiments, portable chargers or portable field chargers of the invention comprise an electronic system comprising a three in one (3-in-1) high precision voltage measurement, smart microcontroller and power distribution module to efficiently regulate and control the output voltages in accordance to rapidly changing load demands. The high precision voltage measurement system detects minute changes in the load voltages due to varying load demands, process the information and output the correction signals rapidly with a high performance microcontroller. This innovative control architecture facilitates the ease of determination of power distribution and safety management.

g. Hybrid Power Configuration/System

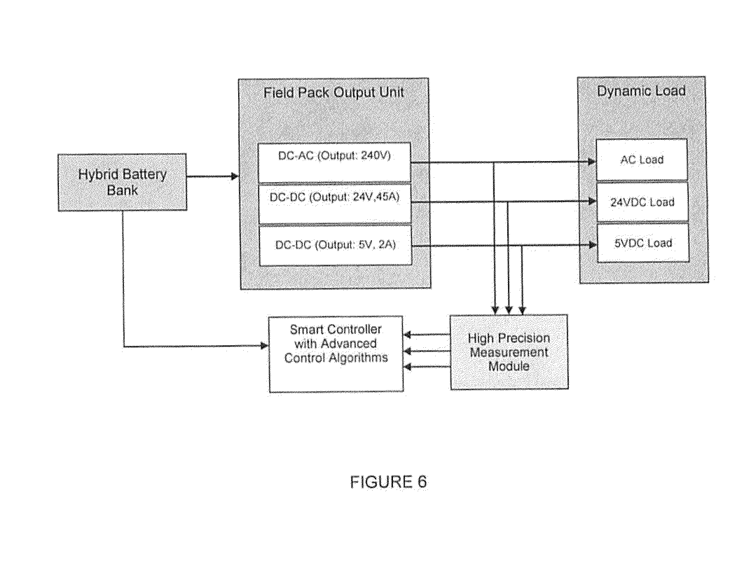

In alternative embodiments, chargers of the invention comprise a battery-battery hybrid configuration/system to match and optimize power and energy demands using an integrated power distribution and innovative control architecture, thereby reducing the cost and complexity of large format lithium battery. FIG. 6 schematically illustrates an alternative embodiment comprising a hybrid battery bank operably linked to a controller with control algorithms and a field pack output unit that comprises a plurality of DC-AC and DC-DC outputs, e.g. as illustrated in FIG. 6. In the embodiment illustrated in FIG. 6, the field pack output unit is operatively linked to a dynamic load and a precision measurement module, e.g. as illustrated in FIG. 6. In alternative embodiments the precision measurement module is a high precision measurement module, and this can be operatively linked to a smart controller with control algorithms.

i. Fuel Cell-Battery Hybrid Power System

In alternative embodiments, chargers of the invention comprise a hydrogen fuel cell comprising a battery hybrid power configuration to meet long duration power demands as well as heavy power demands. Fuel cells can offer exceptionally quiet operation, highly efficient use of the fuel energy, and a high energy storage density compared to batteries; leading to much longer discharge time. By using a low power fuel cell to charge the battery and provide nominal load demands, the hybridization extends the operating lifetime of the stack and battery. The hybrid configuration also increases the overall system efficiency by limiting the operation of the fuel cell at above 0.7 v/cell.

In alternative embodiments the hybrid battery is configured to only provide instantaneous power and peak requirements. The smart controller can sense and optimally switch between the two power sources to meet the load demand. The degree of hybrid can depend on the load requirements and can be adjusted to maximize runtime and lifetime.

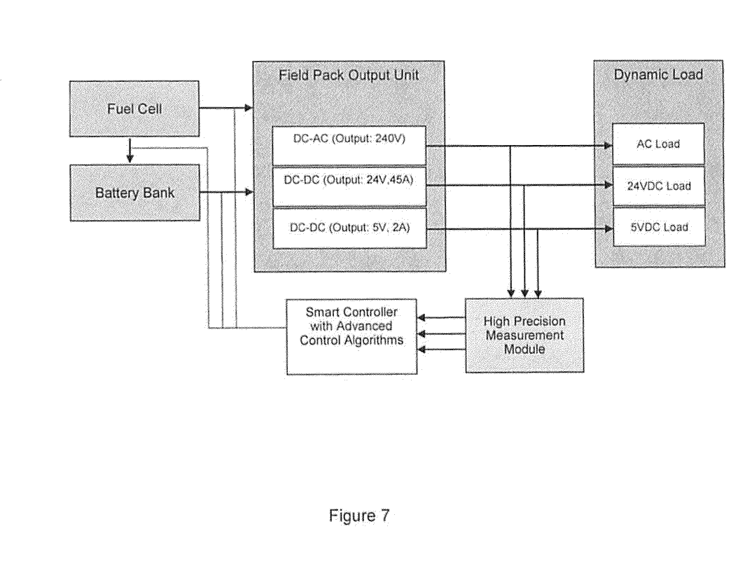

For example, FIG. 7 schematically illustrates an exemplary fuel cell hybrid power system of the invention comprising a fuel cell operatively linked to a battery pack, which both are operatively linked to an output unit. In alternative embodiments the output unit comprises a plurality of DC-AC and DC-DC outputs, e.g. as illustrated in FIG. 7. These outputs can be operatively linked to dynamic loads, e.g. as illustrated in FIG. 7.

j. Air Intake Fans for Cooling

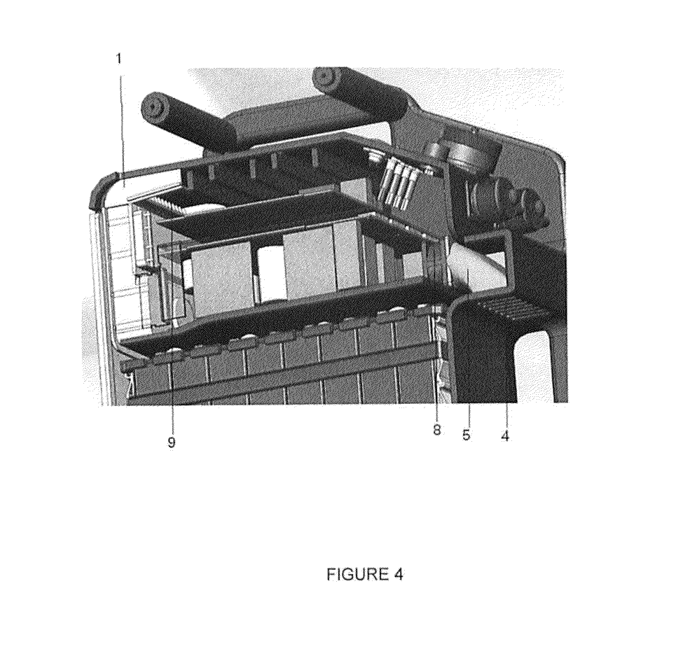

In alternative embodiments, chargers of the invention comprise at least one air intake fan 8 for effective and efficient removal of heat generated by the various power components residing within the jerry can. The air intake fan 8 as shown in FIG. 4 is integrated in the system enabling the invention to operate effectively at heavy loads for long duration over a wide range of ambient temperature and humidity conditions. The integrated fan system also increases the operation life span of the various power components thereby increasing the invention overall operational lifetime. The design of the integrated fan system minimizes water and dust intrusion as the air inlet to the integrated fan is positioned facing downwards while the air duct is extended, elongated and curved upwards towards the fan. In alternative embodiments the air outlet 2 is situated at the upper end of the heat sink 3 part and at opposite end to the integrated fan system such that the exhaust hot air is forced to move over a wide area of the heat sink 3, further enhancing effective heat removal.

A number of embodiments of the invention have been described. Nevertheless, it can be understood that various modifications may be made without departing from the spirit and scope of the invention. Accordingly, other embodiments are within the scope of the following claims.

The term “smart microcontroller”, “controller” and “control architecture” are interchangeable and refer to the same component here. “Smart microcontroller” has the following features:
1. Automatic protection.
2. Single button with multiple functions (ON/OFF controlling, State checking).
3. Status indicator.
4. Automatic charging and discharging mode detection.
5. Energy management to reduce power consumption of the controller.

The microcontroller further includes a battery Management system (BMS) and an inverter. A battery management system (BMS) is an electronic system that manages a rechargeable battery (cell or battery pack), such as by monitoring its state, calculating secondary data, reporting that data, protecting the battery, controlling its environment, and/or balancing it. BMS further provides following:
1. All the safety protections against various conditions which includes: Over Voltage Protection, Low Voltage Protection, Over Current Protection, Short Circuit Protection and Over Temperature Protection.
2. Battery State Prediction with Self-correction function to prevent the drift of the sensor.
3. Multi Function of single button (ON/OFF Switch, State Check) is simple and easy to use.
4. Power saving function to reduce the power consumption of the controller.
5. Automatic detection of charger connection and automatic working state switching.
6. Automatic protection of unpredictable disconnection and charger failure during the charging process.
7. Automatic temperature control.
8. Automatic power range selection for different charging sources.
9. Fault indications

Inverter
1. All the safety protections against various conditions which includes: Over Voltage Protection, Low Voltage Protection and Over Current Protection.
2. Standard interface to connect to any master controller (BMS Card).
3. USART Communication with PC
4. Fault indications (for display and control)

There has thus been shown and described portable charger using the same which fulfills all the objects and advantages sought therefore. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

Advantages of present invention:
1. Light weight.
2. High power density.
3. Portable field charger.
4. Integrated fan system and integrated heat sink 3 that enhances effective heat removal.
5. 2-way valve to equalize pressure fluctuations enable charger operation in differing latitudes.
6. Charger is shaped like a jerry can thereby enabling easy transportation in existing Infra structure and simplifying logistic complexity.
7. The biaxial handlebars enable easy mounting and dismounting on a vehicle.
8. The charger has a ruggged interface to protect and prevent mishandling or accidental damage.

What is claimed is:

1. A portable charger comprising:
a power source;
a housing having a front and back panel;
an integrated electronics comprising a microcontroller, an integrated power distribution module and a voltage measurement module;
an air outlet duct arranged at an upper end of the heat sink inside a ceiling of the housing of the portable charger, to capture and channel an heated air inside the portable charger;
a heat sink arranged on the housing of the portable charger at back panel, and comprising fins matching with the air outlet duct, to receive heated air from the air outlet duct;
an air intake grill arranged in the housing of the portable charger facing downward when the portable charger is placed in a upright position and to receive an air from an outside of the portable charger;
an air intake duct in physical coupling to the air intake grill, to channel the air to an inside of the portable charger;
an intake fan physically coupled to the air intake duct to receive the air;
an air outlet arranged at the upper end of the heat sink and at opposite end to the intake fan, such that the air move over a wide area of the heat sink.

2. The portable charger of claim 1, wherein the
voltage measurement module detects changes in a load voltage and to provide an information related to change in load voltage to the microcontroller, said microcontroller processes the information and provides a correction signal related to the power requirement to a power distribution module, the power distribution module regulates and controls output voltages on a basis of the correction signal.

3. The portable charger of claim 1 comprises:
a hybrid power system comprising a plurality of power sources to power a load, the hybrid power system functionally coupled to the power distribution module to be regulated by the power distribution module for powering the load.

4. The portable charger of claim 2 comprises:
a hybrid power system comprising a plurality of power sources to power a load, the hybrid power system functionally coupled to the power distribution module to be regulated by the power distribution module for powering the load.

5. The portable charger of claim 3 comprises:
a field pack output unit coupled to the hybrid power system, comprising a DC-AC output and DC-DC output, and the field pack output unit is operatively coupled to the load.

6. The portable charger of claim 4 comprises:
a field pack output unit coupled to the hybrid power system, comprising a DC-AC output and DC-DC output, and the field pack output unit is operatively coupled to the load.

7. The portable charger of claim 3, wherein the hybrid power system comprises a hydrogen fuel cell.

8. The portable charger of claim 4, wherein the hybrid power system comprises a hydrogen fuel cell.

9. The portable charger of claim 5, wherein the hybrid power system comprises a hydrogen fuel cell.

10. The portable charger of claim 6, wherein the hybrid power system comprises a hydrogen fuel cell.

11. The portable charger of claim 1, wherein the housing is in the shape of a jerry can.

12. The portable charger of claim 2, wherein the housing is in the shape of a jerry can.

13. The portable charger of claim 1, wherein the housing comprises a pair of bi-axial handles provided on a side surface of the housing and a top surface of the housing along axis perpendicular to each other.

14. The portable charger of claim 2, wherein the housing comprises a pair of bi-axial handles provided on a side surface of the housing and a top surface of the housing along axis perpendicular to each other.

15. The portable charger of claim 1, wherein the housing comprises connectors to connect the portable charger to the load, and the connectors are placed at one of the edges of the housing.

16. The portable charger of claim 2, wherein the housing comprises connectors to connect the portable charger to the load, and the connectors are placed at one of the edges of the housing.

17. The portable charger of claim 3, wherein the microcontroller switches between the power sources to enable the hybrid power system to power the load.

18. The portable charger of claim 4, wherein the microcontroller switches between the power sources to enable the hybrid power system to power the load.

19. The portable charger of claim 5, wherein the microcontroller switches between the power sources to enable the hybrid power system to power the load.

20. The portable charger of claim 6, wherein the microcontroller switches between the power sources to enable the hybrid power system to power the load.
